(19) United States
(12) Patent Application Publication
(10) Pub. No.: US 2016/0008897 A1
(43) Pub. Date: Jan. 14, 2016

(54) Saw Blade Lubrication and Temperature Control System

(71) Applicant: WaneShear Technologies LLC, Ukiah, CA (US)

(72) Inventor: Ronald W. McGehee, Point Roberts, WA (US)

(73) Assignee: WANESHEAR TECHNOLOGIES LLC, Ukiah, CA (US)

(21) Appl. No.: 14/794,625

(22) Filed: Jul. 8, 2015

Related U.S. Application Data
(60) Provisional application No. 62/023,012, filed on Jul. 10, 2014.

(51) Int. Cl. B23D 59/02; B27B 5/29

(52) U.S. Cl. CPC B23D 59/02; B27B 5/29

(57) ABSTRACT

A saw guide assembly includes a stack of saw guides with bodies having a second portion with lubricant holes and coolant holes extending between the first and second surfaces on opposite sides thereof. The lubricant and coolant holes are aligned so that fluid supplied to any of the lubricant or coolant holes of a saw guide at one end of the stack passes into the corresponding holes of at least some of the remaining saw guides in the stack. The first portion has a first saw blade engagement surface with a lubricant distribution region and a coolant distribution region. Coolant and lubricant transfer paths extend from selected coolant and lubricant holes for that saw guide to the coolant and lubricant distribution regions. The coolant and lubricant transfer paths are different for at least some of the saw guides for separate delivery to the distribution regions.

### CROSS-REFERENCE TO OTHER APPLICATIONS

This application claims the benefit of U.S. provisional patent application No. 62/023,012, filed 10 Jul. 2014, entitled Saw Guide Lubrication and Saw Temperature Control System.

### BACKGROUND OF THE INVENTION

The lumber industry uses thin kerf guided circular saws in the process of making lumber out of logs. The thin kerf saw blades require precision saw guiding means to ensure that the saw blades cut the proper path through the wood to make on-size lumber. The current state of the art for saw guides and saw lubrication and cooling is described in U.S. Pat. No. 4,635,512 and U.S. Pat. No. 4,848,200. The methods described in these patents include dispensing liquid lubricant and coolant through the saw guide block onto the surface of the saw blade. In U.S. Pat. No. 4,635,512 separate paths are used to apply the lubricant and coolant to the surface of the saw blade. In each of these inventions, the flow of lubricant and coolant is not precisely metered to each individual saw blade, but rather applied in a somewhat random fashion. Both the coolant and the lubricant are fed into a common gallery that connects to each saw guide so that the volumetric distribution of these liquids to each individual saw blade is dependent upon several factors. These factors include difference in the pressure drop in the galleries going to each saw guide in the stack of saw guides, the orifice area of the outlets for each saw guide, and the overall pressure of the lubricant and coolant being delivered. Each saw blade, often referred to simply as a saw, in the system typically gets approximately the same amount of lubricant and coolant with differences depending upon the variables involved. Saws that may saw less often than other saws in the stack still get approximately the same amount of liquid as the saws that are sawing every piece that goes through the machine. This causes a large amount of waste of both the coolant and the lubricant because the saw not sawing does not need but a small percentage of the coolant and lubricant as the saw that is actually sawing. See also U.S. Pat. No. 6,612,216.

### BRIEF SUMMARY OF THE INVENTION

A saw guide assembly includes a stack of saw guides; each saw guide includes a body having first and second portions. The second portion for each saw guide includes first and second surfaces on opposite sides of the second portion, a plurality of lubricant holes extending between the first and second surfaces, and a plurality of coolant holes extending between the first and second surfaces. The lubricant holes and coolant holes are aligned with one another so that fluid supplied to any of the plurality of lubricant holes or coolant holes of a saw guide at one end of the stack passes into the corresponding lubricant holes or coolant holes of at least some of the remaining saw guides in the stack. The first portion has a first saw blade engagement surface with a first lubricant distribution region and a first coolant distribution region formed therein. For each saw guide, a first coolant transfer path extends from a selected coolant hole for that saw guide to the first coolant distribution region. Also, for each saw guide, a first lubricant transfer path extends from a selected lubricant hole for that saw guide to the first lubricant distribution region. The first coolant transfer path and the first lubricant transfer path are different for at least some of the saw guides so that lubricant and coolant can be separately provided to the lubricant and coolant distribution regions thereof.

Examples of the saw guide assembly may include one or more the following. Temperature sensors may be provided at the first portions of at least some of the saw guides, whereby the temperature of a saw blade adjacent to the temperature sensor can be measured. The saw blade temperature sensors may generate saw blade temperature signals; a lubricant distribution system, coupled to the saw blade temperature sensors, may supply lubricant to at least some of the lubricant holes based at least in part on the saw blade temperature signals. At least some of the saw guides may have a second saw blade engagement surface, the second saw blade engagement surface comprising a second lubricant distribution region and a second coolant distribution region formed therein. Fluid supplied to any of the plurality of lubricant holes, or to any of the plurality of coolant holes, of a saw guide at one end of the stack of saw guides may pass into the corresponding plurality of lubricant holes, or into the corresponding plurality of coolant holes, of all of the remaining saw guides in the stack of saw guides. The first lubricant transfer path and/or the first coolant transfer path can be different for each saw guide.

Other features, aspects and advantages of the present invention can be seen on review the drawings, the detailed description, and the claims which follow.

### BRIEF DESCRIPTION OF THE DRAWINGS

FIG. 1 is an overall view of a seven-saw sawing system.

FIG. 2 is a top view of the sawing system of FIG. 1.

FIG. 3 is a side elevation view of the saw guide assembly of FIG. 1.

FIG. 4 is an isometric view of the saw guide assembly of FIG. 3.

FIG. 5 is an isometric view of a specific saw guide, that is saw guide 2 of FIGS. 3 and 4.

FIG. 6 is a transparent side view of the saw guide of FIG. 5 showing hidden holes, channels and pathways in dashed lines.

FIG. 6A is a simplified view of the structure of FIG. 6 but highlighting the visible and hidden holes, channels and pathways formed in saw guide 2 and used to transport fluid to the lubricant and coolant distribution channels on one side of the saw guide.

FIG. 7 is a transparent perspective view of the saw guide of FIG. 5 illustrating hidden holes, channels and pathways in dashed lines.

FIG. 7A is a simplified view of the structure of FIG. 7 illustrating the external and hidden holes, channels and pathways formed in saw guide 2 and used to transport fluid to the lubricant and coolant distribution channels on both sides of the saw guide.

FIG. 8 is a simplified view of the opposite side of the saw guide of FIG. 6 highlighting the visible and hidden holes, channels and pathways formed in the saw guide and used to transport fluid to the lubricant and coolant distribution channels on the opposite side of the saw guide, and also showing 3 infrared temperature sensors on the opposite side.

FIG. 9 shows the saw guide of FIG. 8 with the saw guiding bearing pad removed showing a 3 output wireless temperature sensor assembly mounted within a recess in the body of the saw guide.

FIG. 10 is an isometric view the 3 output wireless temperature sensor assembly of FIG. 9.

FIG. 11 is a side view of the saw guide of FIG. 8 but adjacent to a saw blade on its far side, the saw guiding bearing pad having the infrared temperature sensors and showing the circular temperature sensor path lines.

FIG. 12 is an overall view of a portion of a wood sawing machine including the sawing system of FIG. 1 and a saw lubricant and coolant dispensing system.

FIG. 13 is a schematic representation of the main components of the saw lubricant and coolant dispensing system of FIG. 12.

### DETAILED DESCRIPTION

The following description will typically be with reference to specific structural embodiments and methods. It is to be understood that there is no intention to limit the invention to the specifically disclosed embodiments and methods but that the invention may be practiced using other features, elements, methods and embodiments. Preferred embodiments are described to illustrate the present invention, not to limit its scope, which is defined by the claims. Those of ordinary skill in the art will recognize a variety of equivalent variations on the description that follows. Unless otherwise stated, in this application specified relationships, such as parallel to, aligned with, or in the same plane as, mean that the specified relationships are within limitations of manufacturing processes and within manufacturing variations. When components are described as being coupled, connected, being in contact or contacting one another, they need not be physically directly touching one another unless specifically described as such. Like elements in various embodiments are commonly referred to with like reference numerals.

The current invention is an improvement over the current state of the art because it allows for the metering of both coolant and lubricant to each saw blade individually. By individually metering the coolant and lubricant to each saw blade, the volumetric usage of both the coolant and the lubricant is greatly reduced. In actual use these reductions were measured and the usage was decreased to approximately 10 percent of a current state of the art system. There are methods to detect which saws are sawing and which saws are just idling during the processing of any given work piece. This invention uses this information to regulate the volume of lubricant and coolant that is dispensed to any given saw blade in the system. This invention goes a step farther by measuring the temperature of the saw blade in several places to determine if that individual saw blade need more or less coolant and/or lubricant. The current invention has huge positive environmental impact because it greatly reduces the usage of saw blade cooling liquid, typically water, and saw blade lubricating fluid. The proper lubricating and cooling of guided circular saws is import to assure accurate sawing to minimize wood waste.

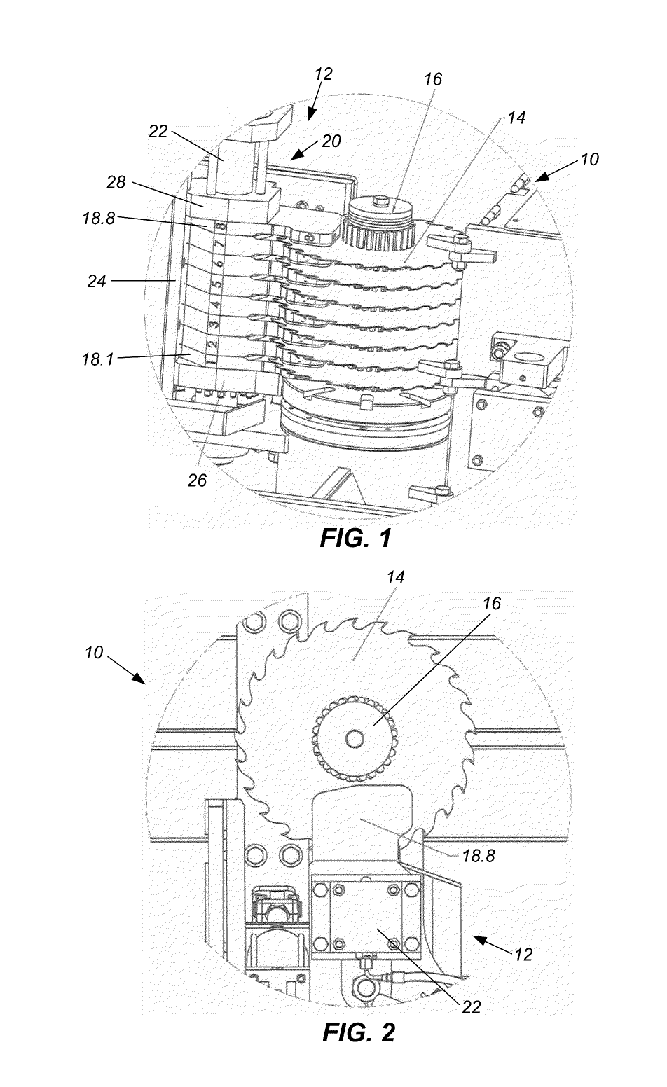

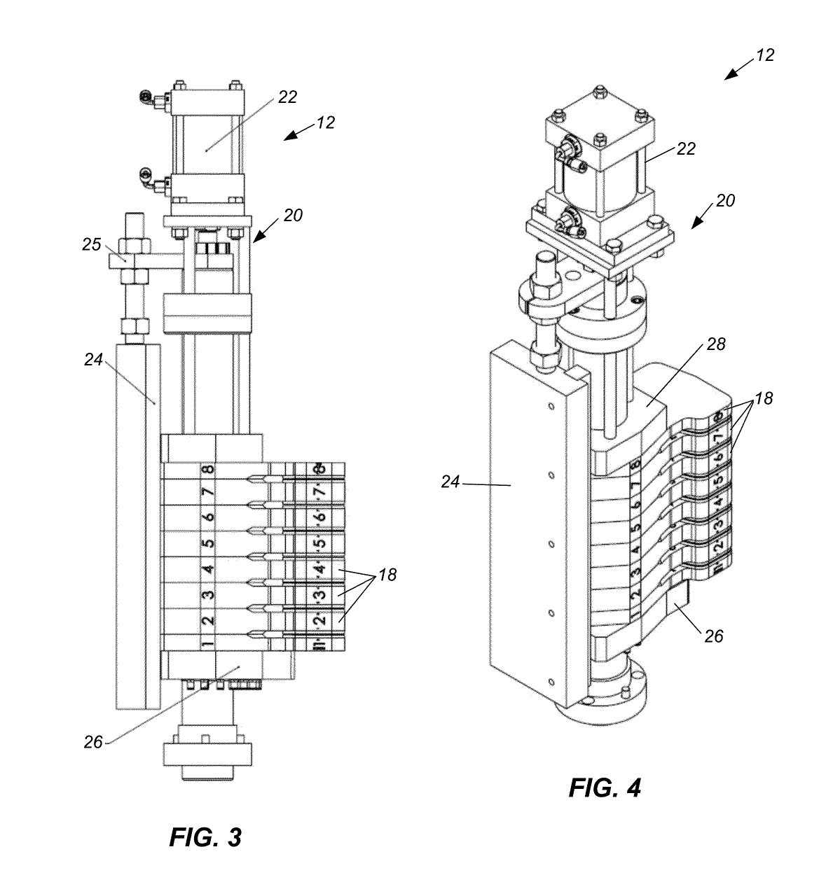

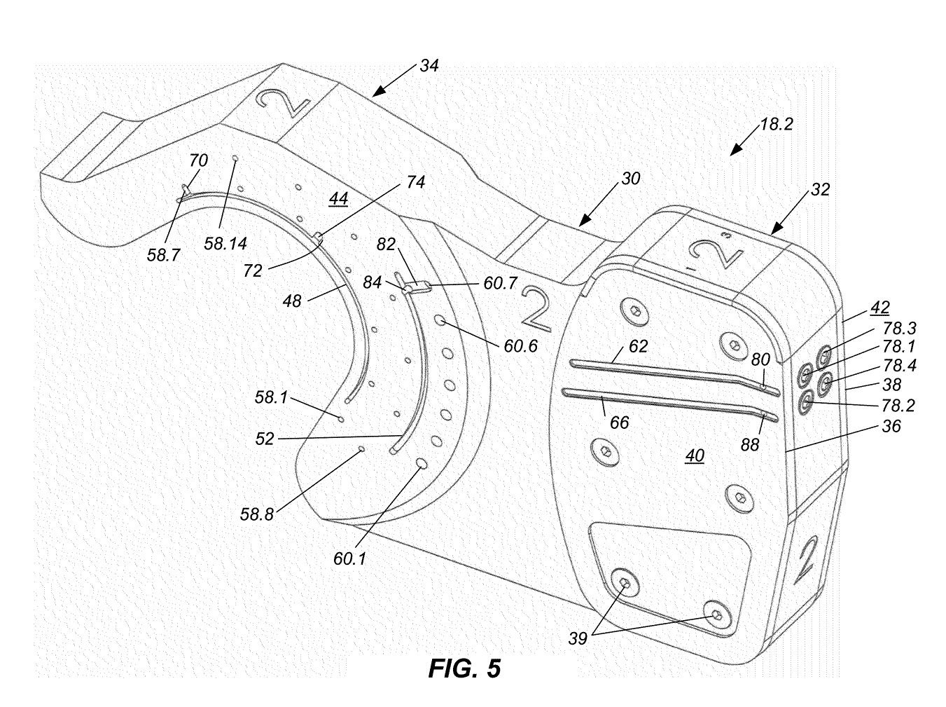

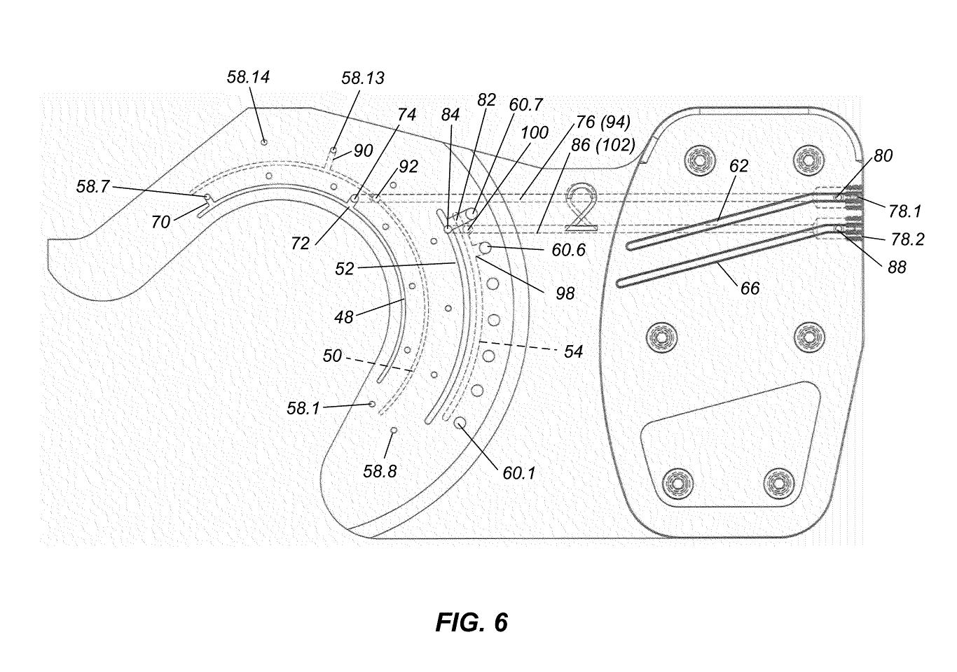

FIGS. 1 and 2 illustrate a seven-saw sawing system 10 including a saw guide assembly 12 used to guide a stack of circular saw blades 14 mounted to a splined arbor 16. FIGS. 3 and 4 are side elevation and isometric views of the saw guide assembly 12 of FIG. 1. Saw guide assembly 12 is shown to include, in this example, eight saw guiding and spacing blocks 18, referred to as saw guides 18, including saw guides 18.1-18.8. Saw guide 18.1 and saw guide 18.8 are single-sided saw guides, because they engage only a single saw blade 14, while saw guides 18.2-18.7 are double-sided saw guides. Assembly 12 includes a saw guide mounting assembly 20 including a clamping cylinder 22 at one end and a stop bar 24 to prevent rotation of saw guides 18 during use. Mounting assembly 20 also includes a lateral adjuster 25 which allows the entire saw assembly to be moved along the axis perpendicular to the face of the saw guides. A combination lubricant and coolant manifold 26 is located adjacent to saw guide 18.1. Clamping cylinder 22 supplies sufficient force against a clamping plate 28 located adjacent to saw guide 18.8 to secure the saw guides 18 between manifold 26 and clamping plate 28.

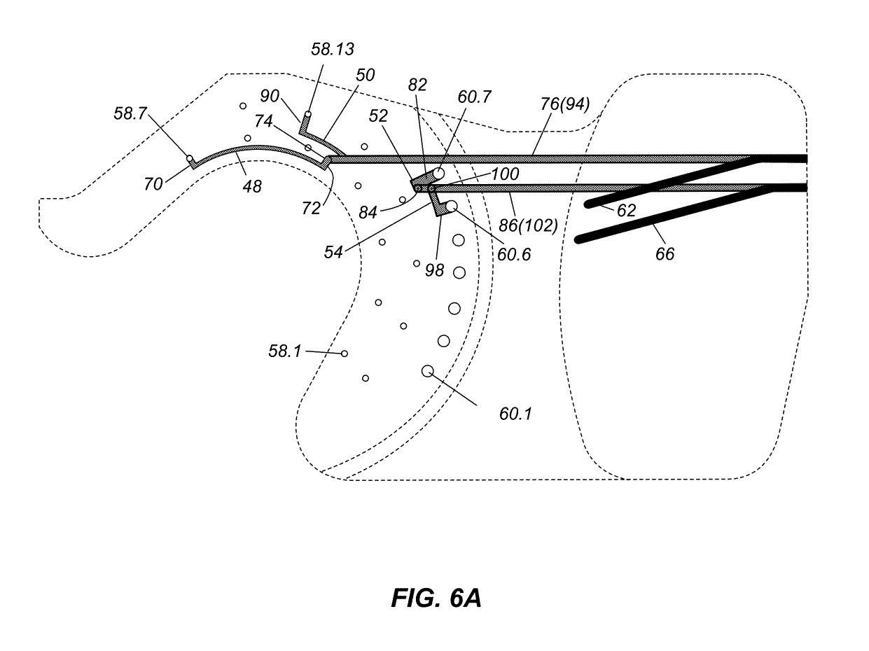

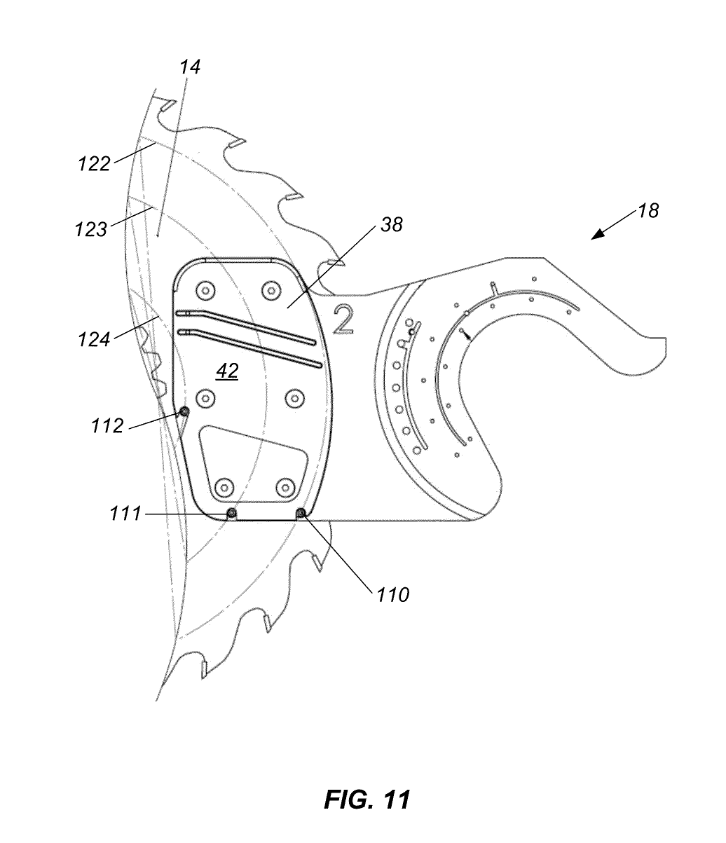

FIG. 5 is an isometric view of an individual saw guide 18, in particular saw guide 18.2, which is a double-sided saw guide. Saw guide 18.2 has a body 30 with a first portion 32 and a second portion 34. First portion 32 has a first bearing pad 36 mounted on one side and a second bearing pad 38 mounted the on the other side, both with screws 39. This provides saw guide 18.2 with first and second saw blade engagement surfaces 40, 42, surface 42 and bearing pad 38 shown in FIG. 11.

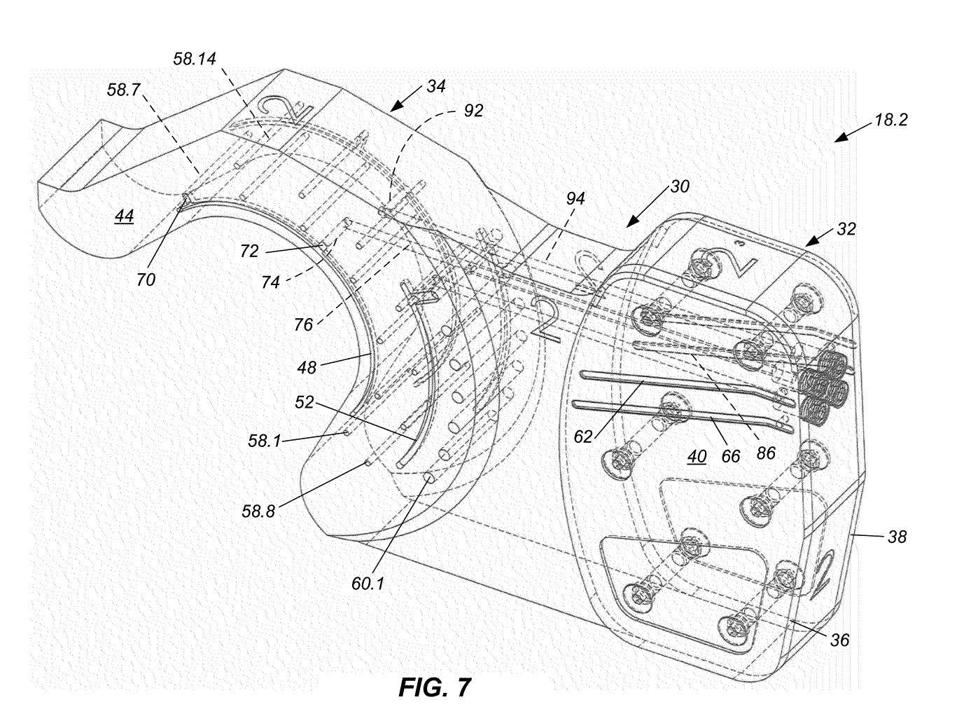

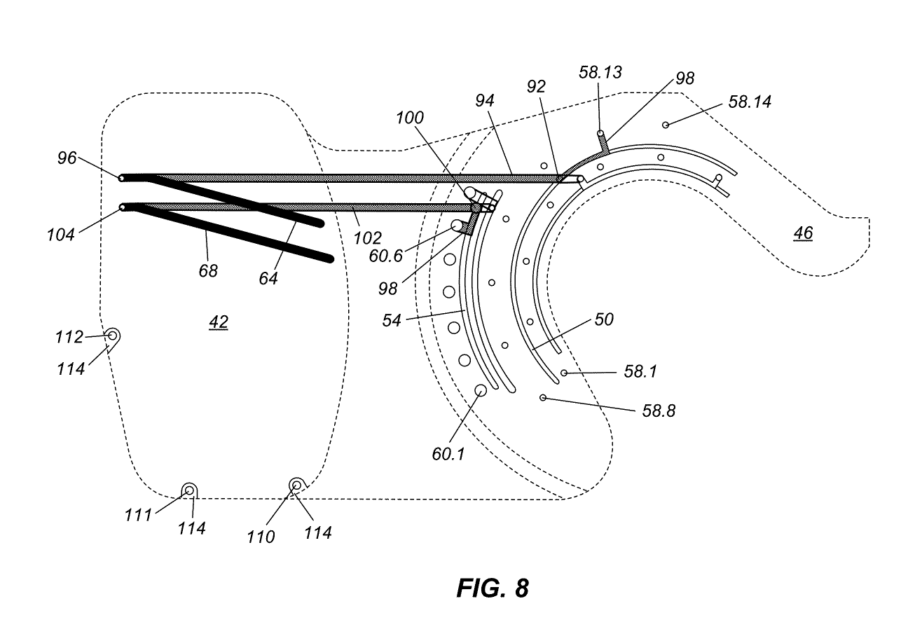

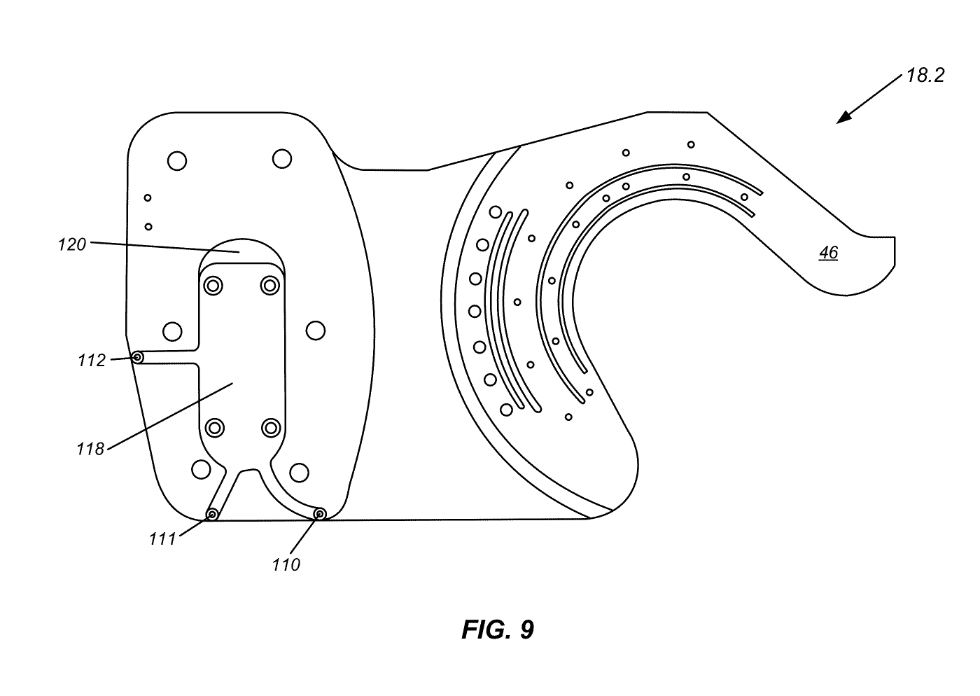

Second portion 34 of body 30 has a first surface 44 and a second surface 46, second surface 46 shown in FIG. 8. First surface 44 has a first lubricant groove 48 while second surface 46 has a second lubricant groove 50. Lubricant grooves 48, 50 typically have a U cross-sectional shape with a width and a depth of, for example, about 0.125 inch×0.125 inch. As illustrated in FIG. 6, lubricant grooves 48, 50 are axially offset so that lubricant is not transferred directly between lubricant grooves 48, 50 of adjacent saw guides 18. First surface 44 also has a first coolant groove 52 and second surface 46 also has a second coolant groove 54. Coolant grooves 52, 54 typically have a U cross-sectional shape with a width and a depth of, for example, about 0.125″×0.125″. As with lubricant grooves 48, 50, coolant grooves 52, 54 are axially offset. Lubricant groove 48 and coolant groove 52 are shown in solid lines in FIGS. 8 and 9 to for ease of illustration.

Second portion 34 of body 30 has two different types of through holes passing completely through body 30 from first surface 44 to second surface 46. The through holes include 14 lubricant holes 58.1 through 58.14 and 7 coolant holes 60.1 through 60.7. First and second lubricant distribution channels 62, 64 and first and second coolant distribution channels 66, 68 are formed in first and second saw blade engagement surfaces 40, 42, respectively. The construction of saw guides 18 as thus far described is identical with regard to saw guide 18.2 through saw guide 18.7.

Manifold 26 is used to separately supply lubricant, such as light grease, to each of lubricant holes 58.1-58.14 and separately supply coolant, such as water or a water-based coolant, to each of coolant holes 60.1-60.7. Saw guide 18.1 does not have a first bearing pad 36 because no saw blade is provided on that side. Similarly, saw guide 18.8 does not have a second bearing pad 38.

The way by which lubricant is provided to first and second lubricant distribution channels 62, 64 and coolant is supplied to first and second coolant distribution channels 66, 68 will now be discussed specifically with regard to saw guide 18.2 and with reference to FIGS. 6-8.

The supply of lubricant to first lubricant distribution channel 62 of saw guide 18.2 will be discussed first. Referring now to FIGS. 6A, 7A and 8, a relatively short connection channel 70 is formed in first surface 44 of saw guide 18.2 to fluidly connect lubricant hole 58.7 to first lubricant groove 48. A connection channel 72, also relatively short, is formed in first surface 44 of saw guide 18.2 to fluidly connect first lubricant groove 48 with a first bore 74 extending perpendicular to first surface 44. First bore 74 opens into and terminates at one end of a first pathway 76. First pathway 76 extends into and through first portion 32 of body 30, the end of first pathway 76 being sealed by a plug 78.1. A connection channel 80 fluidly connects first pathway 76 to first lubricant distribution channel 62. A lubricant transfer path thus extends from lubricant hole 58.7, through connection channel 72, through first lubricant groove 48, through first bore 74, through first pathway 76, and through connection channel 80 for connection to first lubricant distribution channel 62. Each of the elements 70-80 is specific to saw guide 18.2.

Next, the supply of coolant to first coolant distribution channel 66 will be discussed. A connection channel 82 is formed the first surface 44 of saw guide 18.2 to fluidly connect coolant hole 60.7 to first coolant groove 52. A second bore 84, which extends perpendicular to first surface 44, fluidly connects first coolant groove 52 to one end of a second pathway 86. Second bore 84 terminates at second pathway 86. Second pathway 86 extends into and through first portion 32 of body 30, the end of which is sealed by a plug 78.2. A connection channel 88 fluidly connects second pathway 86 to first coolant distribution channels 66. Each of elements 82-88 is specific to saw guide 18.2. A coolant transfer path thus extends from coolant hole 60.7, through connection channel 82, through first coolant groove 52, through second bore 84, through second pathway 86, and through connection channel 88 for connection to first coolant distribution channel 66.

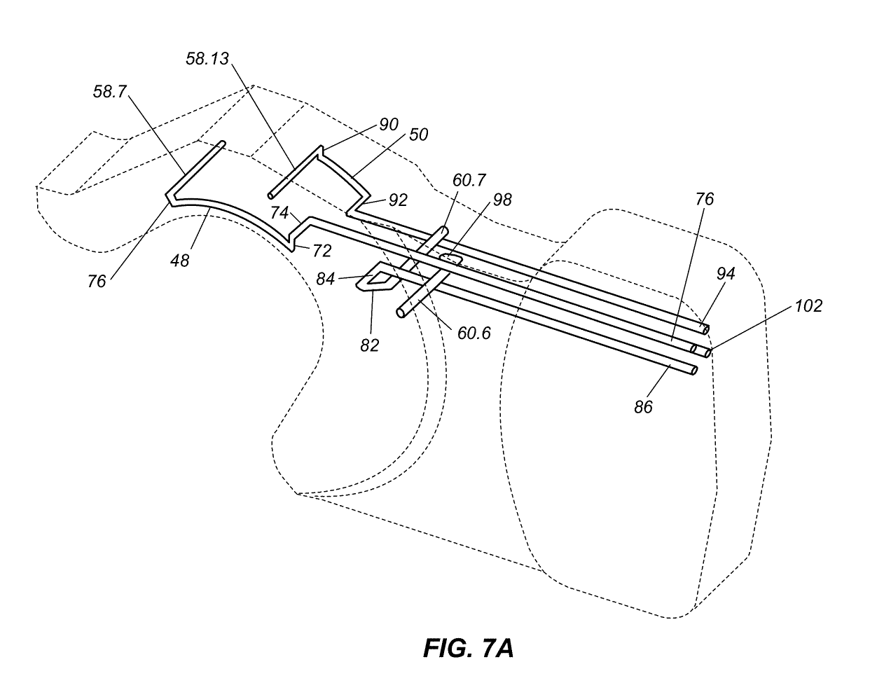

Next, the supply of lubricant to second lubricant distribution channel 64, see FIGS. 7A and 8, will be discussed. A connection channel 90, oriented generally perpendicular to second surface 46, is formed in second surface 46 to fluidly connect lubricant hole 58.13 to second lubricant groove 50. A third bore 92 is formed in saw guide 18.2 extending perpendicular to second surface 46 to fluidly connect second lubricant groove 48 to one end of a third pathway 94. Third pathway 94 is situated directly behind first pathway 76 in FIGS. 6 and 6A so that it is identified in those figures in parentheses following reference numeral 76. Third bore 92 opens into and terminates at third pathway 94. Third pathway 94 extends into and through first portion 32 of body 30, the end of which is sealed by a plug 78.3. A connection channel 96, see FIG. 8, fluidly connects third pathway 94 to second lubricant distribution channel 64. Each of the elements 90-96 is specific to saw guide 18.2.

Next, the supply of coolant to second coolant distribution channel 68 will be discussed. A connection channel 98 is formed the second surface 46 of saw guide 18.2 to fluidly connect coolant hole 60.6 to second coolant groove 54. A fourth bore 100, see FIG. 6, which extends perpendicular to second surface 46, fluidly connects second coolant groove 54 to one end of a fourth pathway 102. Fourth pathway 102 is situated directly behind second pathway 86 in FIGS. 6 and 6A so that it is identified in those figures in parentheses following reference numeral 86. Fourth bore 100 extends to and terminates at fourth pathway 102. Fourth pathway 102 extends into and through first portion 32 of body 30, the end of which is sealed by a plug 78.4. A connection channel 104, see FIG. 8, fluidly connects fourth pathway 102 to second coolant distribution channels 68. Each of elements 98-104 is specific to saw guide 18.2.

Saw guides 18.1 and 18.3-18.7 have connection channels, bores and pathways similar to those of saw guide 18.2 but specific for each saw guide. In this example each lubricant hole 58.1 through 58.14 provides lubricant to a single lubricant groove on one saw guide 18. In this example each coolant hole 60.1 through 60.7 provides coolant to two different coolant grooves on the same or different adjacent saw guides 18. To do so each coolant hole 60.1-60.7 is connected to two coolant grooves 52/54 which may be on the same saw guide 18 or different adjacent saw guides 18.

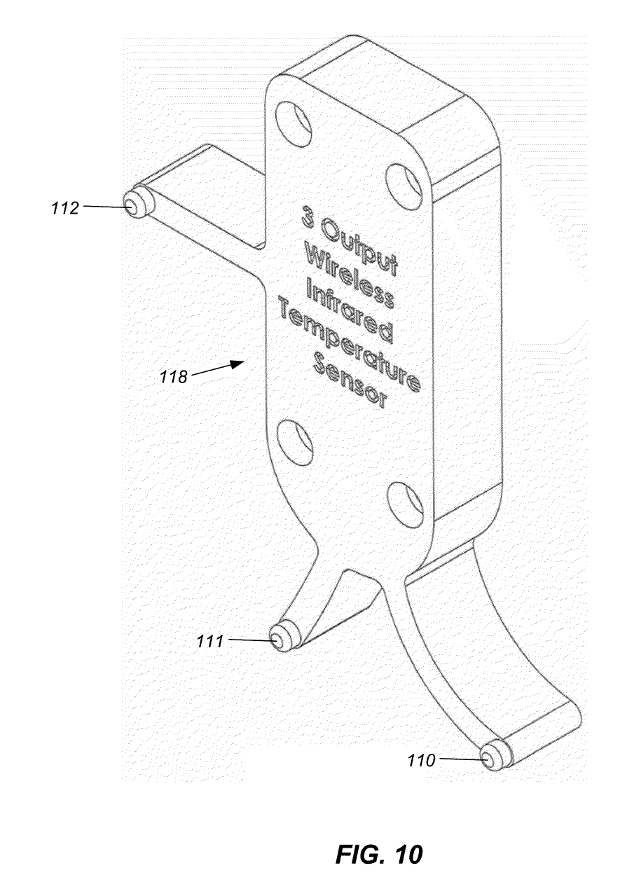

Referring now to FIGS. 8-11, three temperature sensors 110, 111 and 112, which in this example are infrared temperature sensors, are used to monitor the temperature of the saw blade 14 abutting second saw blade engagement surface 42. Cutouts 114 are provided in saw guiding bearing pad 38 to permit direct access to the surface of the saw blade 14 by temperature sensors 110-112. Temperature sensors 110-112 are parts of a wireless temperature sensing assembly 118 positioned within a recess 120 formed in body 30 of saw guide 18.2. Assembly 118 is powered by internal battery. This allows the monitoring of the temperature of each saw blade 14 along three circular, generally equally radially spaced, temperature sensor paths 122, 123, 124. With this information the amount of lubricant and/or coolant delivered to each saw blade 14 can be monitored and controlled to minimize waste and disposal problems while safeguarding the equipment and the product produced. In addition to temperature, other operating characteristics can be used to determine the delivery rate of the lubricant and/or the coolant for each saw guide. These include the physical characteristics of the workpiece, such as a log or cant, including the type of wood, which commonly would not change between a series of workpieces, and the diameter of each workpiece. With smaller diameter workpieces, the saw blades at either end of the stack of saw blades may not even be used to saw the workpiece under consideration; in such cases the amount of lubricant and/or coolant for such unused saw blade can be reduced or eliminated. Other operating characteristics which can affect the delivery rate of lubricant and/or coolant include the following: saw blades getting dull after normal use, damage to the tips of the teeth of some of the saw blades, and sawing certain types of timber which deflect immediately upon being cut.

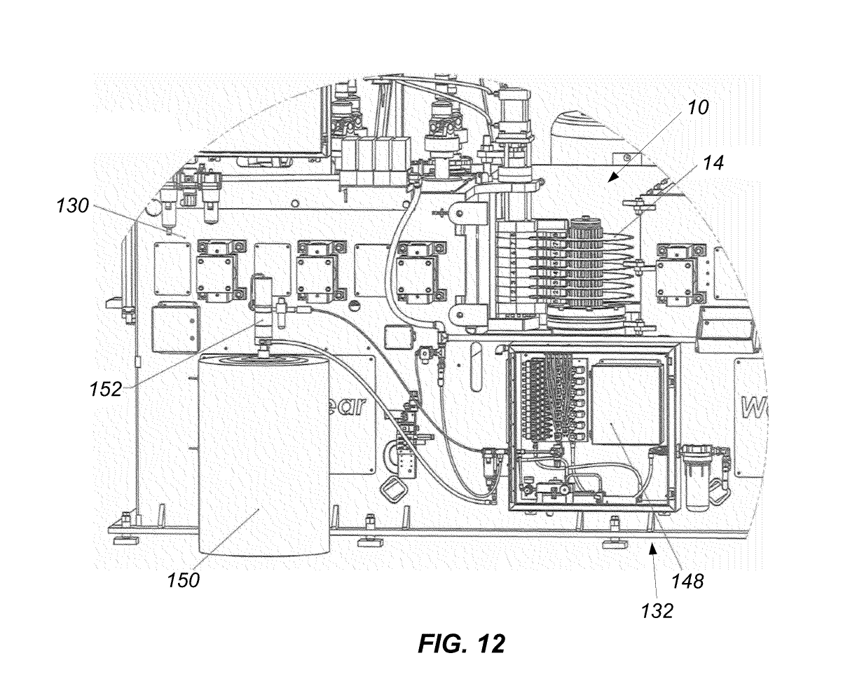

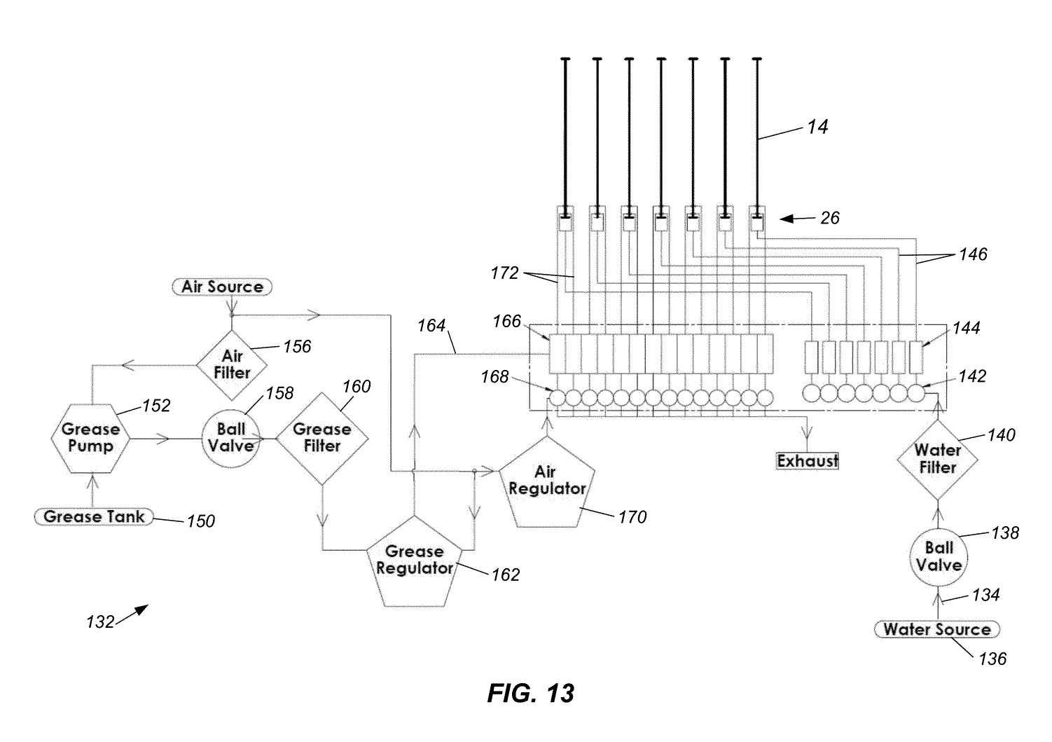

FIG. 12 is an overall view of a portion of a wood sawing machine 130 including the sawing system 10 of FIG. 1 and a saw lubricant and coolant dispensing system 132. FIG. 13 is a schematic representation of the main components of the saw lubricant and coolant dispensing system 132 of FIG. 12. The saw lubricant and coolant dispensing system 132 provides coolant and lubricant to manifold 26 of sawing system 10. System 132 includes a water inlet 134 connected to a water source 136, water being the liquid coolant. The liquid water coolant passes through a ball valve 138 and a water filter 140 for delivery to a set of 7 water valves 142. The liquid coolant water passes from water valves 142 to a set of 7 flow switches 144. Water is delivered to manifold 26 through a set of 7 lines 146. A controller 148 controls the operation of water valves 142 and monitors the flow switches 144 to control and confirm the flow of liquid coolant through lines 146 to manifold 26.

A supply of lubricant is provided by lubricant tank 150 to a lubricant pump 152. Lubricant pump 152 is powered by air from a pressurized air source 154, the air first passing through an air filter 156. The lubricant from pump 152 passes through a ball valve 158, a lubricant filter 160, and a lubricant regulator 162. Lubricant regulator 162 delivers lubricant through a line 164 to a set of 16 lubricant dispensers 166. A set of 16 air valves 168, powered by pressurized air from air source 154 through an air regulator 170, are connected to the set of 16 lubricant dispensers 166. Lubricant passes from lubricant dispensers 166 through lines 172 to manifold 26. Controller 148 controls the operation of lubricant dispensers 166 and air valves 168 to control the flow of lubricant through the individual lines 172.

The above descriptions may have used terms such as above, below, top, bottom, over, under, et cetera. These terms may be used in the description and claims to aid understanding what is being disclosed and not used in a limiting sense.

While the present invention is disclosed by reference to the preferred embodiments and examples detailed above, it is to be understood that these examples are intended in an illustrative rather than in a limiting sense. It is contemplated that modifications and combinations will occur to those skilled in the art, which modifications and combinations will be within the spirit of the invention and the scope of the following claims. For example, in some examples it may be desired to supply coolant to only one side of saw blades 14.

One or more elements of one or more claims can be combined with elements of other claims.

Any and all patents, patent applications and printed publications referred to above are incorporated by reference. What is claimed is:

1. A saw guide assembly comprising:
a stack of a chosen number of saw guides, each saw guide comprising:
a body having first and second portions, the second portion for each saw guide comprising:
first and second surfaces on opposite sides of the second portion;
a plurality of lubricant holes arranged in a lubricant hole pattern and extending between the first and second surfaces;
a plurality of coolant holes arranged in a coolant hole pattern extending between the first and second surfaces;
the lubricant holes and coolant holes formed in the stack of the saw guides being aligned with one another, so that:
fluid supplied to any of the plurality of lubricant holes of a saw guide at one end of the stack of saw guides passes into the corresponding plurality of lubricant holes of at least some of the remaining saw guides in the stack of saw guides; and
fluid supplied to any of the plurality of coolant holes of the saw guide at the one end of the stack of saw guides passes into the corresponding plurality of coolant holes of at least some of the remaining saw guides in the stack of saw guides;
the first portion having a first saw blade engagement surface;
the first saw blade engagement surface having a first lubricant distribution region and a first coolant distribution region formed therein;
for each saw guide, a first coolant transfer path extends from a selected coolant hole for said saw guide to the first coolant distribution region;
for each saw guide, a first lubricant transfer path extends from a selected lubricant hole for said saw guide to the first lubricant distribution region; and
the first coolant transfer path and the first lubricant transfer path being different for at least some of the saw guides so that lubricant and coolant can be separately provided to the lubricant and coolant distribution regions thereof.

2. The saw guide assembly according to claim 1, further comprising temperature sensors at the first portions of at least some of the saw guides, whereby the temperature of a saw blade adjacent to the temperature sensor can be measured.

3. The saw guide assembly according to claim 2, wherein each of the saw blade temperature sensors comprises a plurality of sensor elements at the first saw blade engagement surface.

4. The saw guide assembly according to claim 2, wherein:
the saw blade temperature sensors generate saw blade temperature signals; and further comprising:
a lubricant distribution system, coupled to the saw blade temperature sensors, supplying lubricant to at least some of the lubricant holes based at least in part on the saw blade temperature signals.

5. The saw guide assembly according to claim 2, wherein the saw blade temperature sensors are wireless infrared temperature sensors.

6. The saw guide assembly according to claim 1, wherein:
the first portion of the body of at least some of the saw guides has a second saw blade engagement surface, the second saw blade engagement surface comprising a second lubricant distribution region and a second coolant distribution region formed therein; and
for each saw guide of at least some of the saw guides, a second coolant transfer path extends from a selected coolant hole for said saw guide to the second coolant distribution region;
for each saw guide of at least some of the saw guides, a second lubricant transfer path extends from a selected lubricant hole for said saw guide to the second lubricant distribution region.

7. The saw guide assembly according to claim 6, wherein for each of the at least some of the saw guides, the first and second coolant transfer paths extend from the same selected coolant hole.

8. The saw guide assembly according to claim 6, wherein for each of the at least some of the saw guides, the first and second lubricant transfer paths extend from different selected lubricant holes.

9. The saw guide assembly according to claim 6, wherein the chosen number equals 2X, the number of lubricant holes equals 2X, and the number of coolant holes equals X.

10. The saw guide assembly according to claim 1, wherein the first portion comprises a removable and replaceable bearing pad, the bearing pad having the first saw blade engagement surface.

11. The saw guide assembly according to claim 1, wherein the first lubricant and coolant distribution regions are separate regions.

12. The saw guide assembly according to claim 1, wherein:
fluid supplied to any of the plurality of lubricant holes of a saw guide at one end of the stack of saw guides passes into the corresponding plurality of lubricant holes of all of the remaining saw guides in the stack of saw guides; and
fluid supplied to any of the plurality of coolant holes of the saw guide at the one end of the stack of saw guides passes into the corresponding plurality of coolant holes of all of the remaining saw guides in the stack of saw guides.

13. The saw guide assembly according to claim 1, wherein the first lubricant transfer path is different for each saw guide so that lubricant can be separately provided to the lubricant distribution regions of each saw guide.

14. The saw guide assembly according to claim 1, wherein the first coolant transfer path and the first lubricant transfer path are different for each saw guide so that lubricant and coolant can be separately provided to the lubricant and coolant distribution regions of each saw guide.

15. The saw guide assembly according to claim 1, wherein each of the saw guides in the stack of saw guides has the same number of lubricant holes and the same number of coolant holes.

16. A saw guide assembly, for use in guiding rotating saw blades, comprising:
a stack of saw guides, each saw guide comprising:
a body having first and second portions, the second portion for each saw guide comprising:
first and second surfaces on opposite sides of the second portion;
a plurality of lubricant holes arranged in a lubricant hole pattern and extending between the first and second surfaces;
a plurality of coolant holes arranged in a coolant hole pattern extending between the first and second surfaces;
the lubricant holes and coolant holes formed in the stack of the saw guides being aligned with one another, so that:
fluid supplied to any of the plurality of lubricant holes of a saw guide at one end of the stack of saw guides passes into the corresponding plurality of lubricant holes of all of the remaining saw guides in the stack of saw guides; and
fluid supplied to any of the plurality of coolant holes of the saw guide at the one end of the stack of saw guides passes into the corresponding plurality of coolant holes of all of the remaining saw guides in the stack of saw guides;
the first portion having first and second saw blade engagement surfaces;
the first saw blade engagement surface having a first lubricant distribution region and a first coolant distribution region formed therein;
the second saw blade engagement surface having a second lubricant distribution region and a second coolant distribution region formed therein;
for each saw guide, a first coolant transfer path extends from a selected coolant hole for said saw guide to the first coolant distribution region;
for each saw guide of at least some of the saw guides, a second coolant transfer path extends from a selected coolant hole for said saw guide to the second coolant distribution region;
for each saw guide, a first lubricant transfer path extends from a selected lubricant hole for said saw guide to the first lubricant distribution region;
for each saw guide of at least some of the saw guides, a second lubricant transfer path extends from a selected lubricant hole for said saw guide to the second lubricant distribution region;
for each of the at least some of the saw guides, the first and second lubricant transfer paths extend from different selected lubricant holes;
the first coolant transfer path and the first lubricant transfer path being different for each saw guide so that lubricant and coolant can be separately provided to the lubricant and coolant distribution regions of each saw guide; and
temperature sensors at the first portions of each of the saw guides, whereby the temperature of saw blades adjacent to the temperature sensors can be measured.

17. The saw guide assembly according to claim 16, wherein:
the saw blade temperature sensors generate saw blade temperature signals; and further comprising:
a lubricant distribution system, coupled to the saw blade temperature sensors, supplying lubricant to at least some of the lubricant holes based at least in part on the saw blade temperature signals.

18. A method for individually supplying liquid coolant and liquid lubricant to individual saw guides of a stack of saw guides, the saw guides used to guide rotating saw blades used to cut a wood workpiece, the method comprising:
monitoring the temperature of at least one saw blade guided by the stack of saw guides;
determining a physical characteristic of a wood workpiece;
selecting operating parameters including the results of the temperature monitoring step and the physical characteristic determining step;
determining individualized coolant and lubricant delivery rates for the saw guides based upon the operating parameters selecting step; and
supplying lubricant and coolant at individualized coolant and lubricant delivery rates to at least some of said plurality of the saw guides based upon the delivery rate determining step.

19. The method according to claim 18, wherein the temperature monitoring step comprises monitoring the temperature of each of a plurality of saw blades guided by the stack of saw guides.

20. The method according to claim 18, wherein the physical characteristic determining step comprises:
determining a diametrical dimension of the wood workpiece;
determining the type of wood of the wood workpiece; and
determining if the wood workpiece is from a type of wood which deflects immediately upon being cut.

21. The method according to claim 18, wherein the delivery rate determining step determines delivery rates for both the lubricant and the coolant.

22. The method according to claim 18, wherein the delivery rate determining step determines individual delivery rates for the saw guides so that the delivery rates for adjacent saw guides may be the same or different.
